(19) United States
(12) Patent Application Publication
(10) Pub. No.: US 2021/0181854 A1
(43) Pub. Date: Jun. 17, 2021

(54) DISPLAY PROCESSING DEVICE, DISPLAY PROCESSING METHOD, AND PROGRAM

(71) Applicant: SONY SEMICONDUCTOR SOLUTIONS CORPORATION, Kanagawa (JP)

(72) Inventors: Takaaki NAKAGAWA, Kanagawa (JP); Keita ISHIKAWA, Kanagawa (JP)

(73) Assignee: SONY SEMICONDUCTOR SOLUTIONS CORPORATION, Kanagawa (JP)

(21) Appl. No.: 16/761,052

(22) PCT Filed: Oct. 26, 2018
(86) PCT No.: PCT/JP2018/039839

§ 371 Date: May 1, 2020

(30) Foreign Application Priority Data
Nov. 10, 2017 (JP) 2017-217721

(51) Int. Cl. G06F 3/01; G06F 3/0488; G06T 7/521; G06F 3/0484; G06K 9/00; G06T 19/00; G10L 15/26

(52) U.S. Cl. CPC G06F 3/017; G06F 3/04883; G06T 7/521; G06T 2207/10028; G06K 9/00375; G06T 19/006; G10L 15/26; G06F 3/04845

(57) ABSTRACT

There is provided a display processing device, a display processing method, and a program that can provide a better user experience when performing virtual display on a real space. An indication point recognition processing unit performs recognition processing to recognize an indication point indicating a point on a real space for creating a virtual drawing image that is an image virtually drawn. An operation information acquisition unit acquires operation information according to a user operation that makes a change to the virtual drawing image in creation. Then, a virtual drawing data processing unit generates virtual drawing data for drawing the virtual drawing image created according to the indication point while reflecting the change according to the operation information. A virtual drawing image display processing unit performs display processing to display the virtual drawing image in creation on a display screen in real time on the basis of the virtual drawing data. The present technology can be applied to, for example, an AR display device.

### TECHNICAL FIELD

The present disclosure relates to a display processing device, a display processing method, and a program, and in particular, to a display processing device, a processing method, and a program that can provide a better user experience when performing virtual display on a real space.

### BACKGROUND ART

In recent years, technology to perform display processing that seems like an object displayed on a screen really exists in a real space, such as augmented reality and mixed reality, has been put into practical use. An application is provided that performs virtual display in which an object appears to be placed on a real space, for example, by display processing to display an image captured by a camera on a touch panel and to superimpose on the image an object image by using a so-called smartphone.

Conventionally, in such an application, for example, a user interface is employed to place a virtual object on a real space and to perform an operation on the virtual object by a user performing a touch panel operation. However, such a user interface results in a user experience that gives a feeling that compatibility with a real space is low.

Furthermore, a user interface is provided that performs a virtual display in which when a user moves a smartphone itself, a line is drawn on a real space according to a locus of the smartphone. However, with such a user interface, it is difficult to draw a virtual line on a real space as intended by the user, resulting in a user experience that gives a feeling that a degree of freedom is low.

In contrast to this, for example, a user interface is proposed that captures a user's gesture with a camera, places a virtual object on a real space according to the gesture, and performs an operation on the virtual object.

For example, Patent Document 1 discloses a user interface technology that provides feedback to a user by using a depth sensor to recognize a user's gesture.

### CITATION LIST

### Patent Document

### Patent Document 1: Japanese Patent Application Laid-Open Mo. 2012-221498

### SUMMARY OF THE INVENTION

### Problems to be Solved by the Invention

Meanwhile, in the user interface using the user's gesture as described above, for example, an operation to place a virtual object, an operation to make changes to the placement of the virtual object, or the like need to be performed independently by respectively corresponding gestures. For this reason, for example, it is difficult to perform an operation to change a width, color, or the like of a virtual line continuously while drawing the line on a real space, and it is difficult to provide a good user experience.

The present disclosure has been made in view of such a situation, and is intended to provide a better user experience when performing a virtual display on a real space.

### Solutions to Problems

A display processing device according to one aspect of the present disclosure includes: a recognition processing unit configured to perform recognition processing to recognize an indication point that indicates a point on a real space for creating a virtual drawing image that is an image virtually drawn; an operation information acquisition unit configured to acquire operation information according to a user operation that makes a change to the virtual drawing image in creation; a data processing unit configured to generate virtual drawing data for drawing the virtual drawing image created according to the indication point, while reflecting the change according to the operation information; and a display processing unit configured to perform display processing to display the virtual drawing image in creation on a display screen in real time on the basis of the virtual drawing data.

A display processing method according to one aspect of the present disclosure is to be executed by a display processing device that displays a virtual drawing image that is an image virtually drawn. The method includes: performing recognition processing to recognize an indication point indicating a point on a real space for creating the virtual drawing image; acquiring operation information according to a user operation that makes a change to the virtual drawing image in creation; generating virtual drawing data for drawing the virtual drawing image created according to the indication point, while reflecting the change according to the operation information; and performing display processing to display the virtual drawing image in creation on a display screen in real time on the basis of the virtual drawing data.

A program according to one aspect of the present disclosure causes a computer of a display processing device that displays a virtual drawing image that is an image virtually drawn to perform display processing including: performing recognition processing to recognize an indication point indicating a point on a real space for creating the virtual drawing image; acquiring operation information according to a user operation that makes a change to the virtual drawing image in creation; generating virtual drawing data for drawing the virtual drawing image created according to the indication point, while reflecting the change according to the operation information; and performing display processing to display the virtual drawing image in creation on a display screen in real time on the basis of the virtual drawing data.

According to one aspect of the present disclosure/recognition processing to recognize an indication point that indicates a point on a real space for creating the virtual drawing image that is an image virtually drawn is performed; operation information according to a user operation that makes a change to the virtual drawing image in creation is acquired; virtual drawing data for drawing the virtual drawing image created according to the indication point is generated, while reflecting the change according to the operation information; and display processing to display the virtual drawing image in creation on a display screen in real time on the basis of the virtual drawing data is performed.

### Effects of the Invention

According to one aspect of the present disclosure, it is possible to provide a better user experience when performing a virtual display on a real space.

Note that advantageous effects described here are not necessarily restrictive, and any of the effects described in the present disclosure may be applied.

### BRIEF DESCRIPTION OF DRAWINGS

FIG. 1 is a view showing a usage example of an AR display application.

FIG. 2 is a view showing a display example of an application screen.

FIG. 3 is a view describing a user interface when starting creation of a virtual drawing image.

FIG. 4 is a view describing the user interface when performing an operation to change a line thickness of the virtual drawing image.

FIG. 5 is a view describing the user interface when finishing the creation of the virtual drawing image.

FIG. 6 is a view describing a usage example of creating the virtual drawing image on the basis of voice recognition.

FIG. 7 is a block diagram showing a configuration example of a smartphone to which the present technology is applied.

FIG. 8 is a flowchart describing display processing to be performed in the AR display application.

FIG. 9 is a view describing a first effect display for the virtual drawing image.

FIG. 10 is a view describing a second effect display for the virtual drawing image.

FIG. 11 is a view describing a third effect display for the virtual drawing image.

FIG. 12 is a view describing an example of applying the AR display application to virtual reality.

FIG. 13 is a block diagram showing a configuration example of one embodiment of a computer to which the present technology is applied.

### MODE FOR CARRYING OUT THE INVENTION

A specific embodiment to which the present technology is applied will be described in detail below with reference to the drawings.

<Usage Example of AR Display Application>

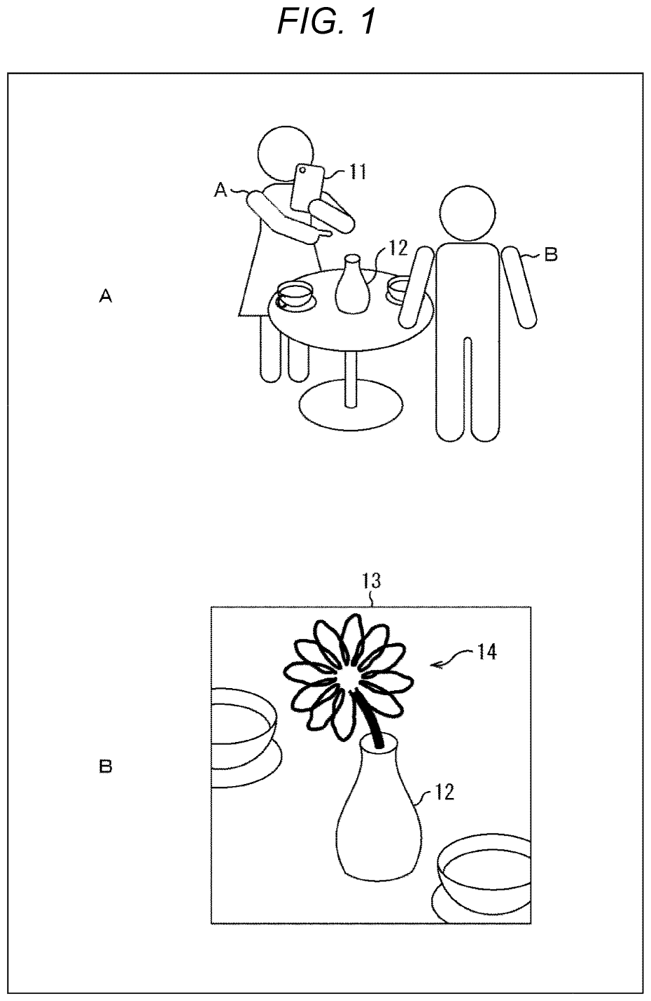

First, with reference to FIGS. 1 to 6, usage examples of an application that implements display processing to which the present technology is applied (hereinafter referred to as an AR display application) will be described. For example, the AR display application can be executed by a smartphone 11 including an image capturing device, a time of flight (TOF) sensor, a touch panel, or the like.

A of FIG. 1 shows a user A using the smartphone 11, and B of FIG. 1 shows an AR image display screen 13 displayed on the touch panel of the smartphone 11.

For example, the user A operates the smartphone 11 to execute the AR display application, and moves a fingertip such that the fingertip appears in an image captured by the image capturing device of the smartphone 11. At this time, a position of the user's fingertip is recognized on the basis of a distance image acquired by the TOF sensor of the smartphone 11. With this configuration, by following a locus of the user's fingertip, the AR display application can display, on the AR image display screen 13, an AR image obtained by superimposing a virtual drawing image 14 drawn by a line following the locus of the fingertip on the image of a real space captured by the image capturing device.

In the usage example shown in A of FIG. 1, the user A points the image capturing device of the smartphone 11 at a vase 12 and moves the fingertip so as to draw a flower arranged in the vase 12. With this configuration, as shown in B of FIG. 1, an AR image in which the virtual drawing image 14 representing the flower virtually drawn by the line corresponding to the locus of the fingertip is arranged in the vase 12 shown in the image of a real space is displayed on the AR image display screen 13.

At this time, a user B sees that the user A is just moving the fingertip in the air, but when the image capturing device of the smartphone 11 is pointed at the vase 12 from the user B side, the virtual drawing image 14 viewed from the user B side is displayed on the AR image display screen 13. That is, the AR display application can generate virtual drawing data for displaying the virtual drawing image 14 (for example, data indicating the locus of the fingertip represented by the absolute coordinate system on a real space) according to the absolute coordinate system on a real space. This allows the AR display application to display the created virtual drawing image 14 on the AR image display screen 13 from all directions like the virtual drawing image 14 is virtually placed on a real space.

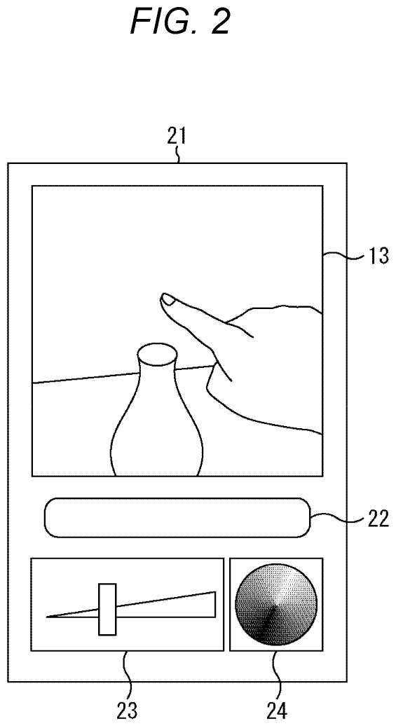

FIG. 2 shows a display example of an application screen displayed on the touch panel of the smartphone 11 when the AR display application is executed.

As shown in FIG. 2, the AR image display screen 13 (see B of FIG. 1) is displayed in an upper part of an application screen 21, and a line drawing operation button 22, a line width operation panel 23, and a line color operation panel 24 are displayed below the AR image display screen 13. For example, the line drawing operation button 22, the line width operation panel 23, and the line color operation panel 24 are preferably displayed within reach of a finger of one hand when the user holds the smartphone 11 with the one hand.

On the AR image display screen 13, the image captured by the image capturing device of the smartphone 11 is displayed in real time, and in superimposition on the image, an AR image is displayed in which the virtual drawing image 14 as described with reference to FIG. 1 is displayed.

The line drawing operation button 22 is a graphical user interface (GUI) for performing an operation to start or finish the creation of the virtual drawing image 14 in response to a touch operation on the touch panel of the smartphone 11. For example, when it is recognized that the user has touched the line drawing operation button 22, while the touch operation of the user is recognized, a line representing the virtual drawing image 14 in creation is displayed according to the locus of the fingertip of the user. Then, when it is recognized that the user has released the touch from the line drawing operation button 22, generation of the virtual drawing image 14 is finished. Note that for example, the operation on the line drawing operation button 22 may switch the start or finish of the creation of the virtual drawing image 14 each time the touch is performed, or when the touch is recognized, the virtual drawing image 14 may be created until the next touch is recognized.

The line width operation panel 23 is a GUI for continuously operating changes to the width of the line representing the virtual drawing image 14 in response to the touch operation on the touch panel of the smartphone 11 while creating the virtual drawing image 14. For example, when a touch operation to move a slider displayed on the line width operation panel 23 to the right is recognized, the line width of the created virtual drawing image 14 is changed to increase according to the position where the slider is moved. Meanwhile, when a touch operation to move the slider displayed on the line width operation panel 23 to the left is recognized, the line width of the created virtual drawing image 14 is continuously changed to decrease according to the position where the slider is moved.

The line color operation panel 24 is a GUI for continuously operating changes to the color of the line representing the virtual drawing image 14 in response to the touch operation on the touch panel of the smartphone 11 while creating the virtual drawing image 14. For example, a color palette representing a hue circle in which RGB values change continuously can be used for the line color operation panel 24, and the color of the created virtual drawing image 14 is changed continuously according to the color displayed at the touch position.

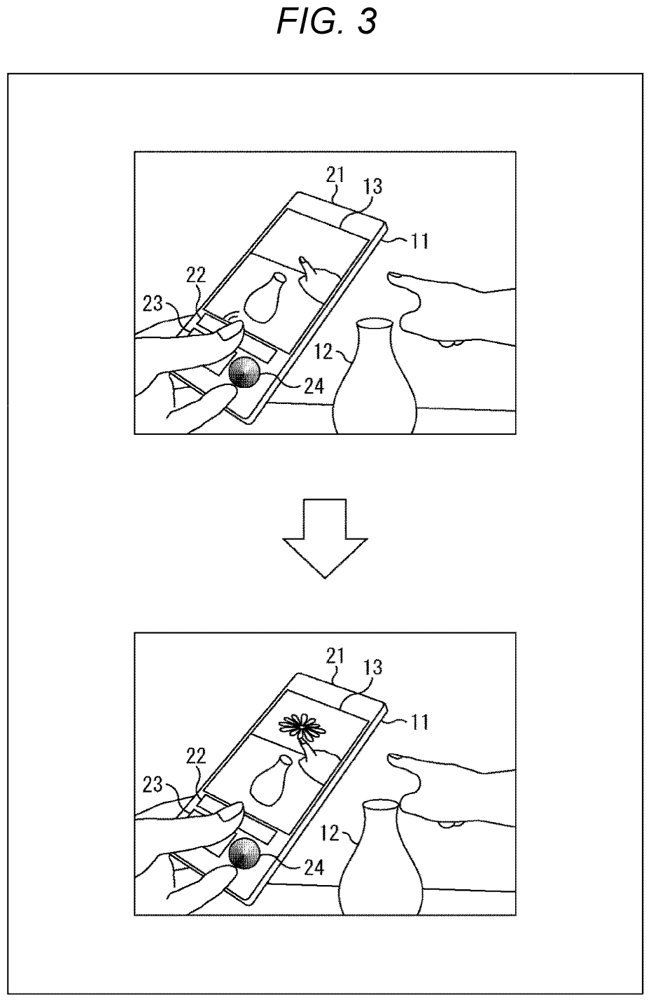

With reference to FIG. 3, a user interface when starting creation of the virtual drawing image 14 in the AR display application will be described.

For example, as shown in an upper side of FIG. 3, when the user moves the fingertip of the right hand to a position to start drawing the virtual drawing image 14 and then performs a touch operation to touch the line drawing operation button 22 with the left finger, the creation of the virtual drawing image 14 is started. Then, when the user moves the fingertip of the right hand while performing the touch operation on the line drawing operation button 22, the virtual drawing image 14 is created according to the locus of the fingertip. With this operation, as shewn in a lower side of FIG. 3, an AR image in which the virtual drawing image 14 is placed on a real space is displayed on the AR image display screen 13.

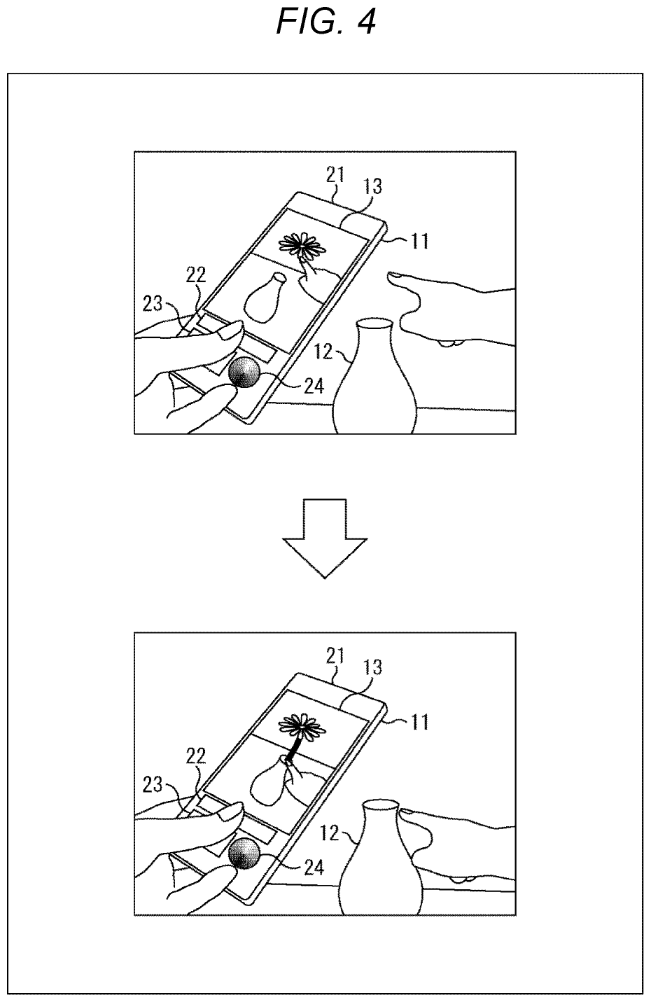

With reference to FIG. 4, a user interface for performing an operation to change the line thickness of the virtual drawing image 14 in the AR display application will be described.

For example, as shown in an upper side of FIG. 4, when the user moves the fingertip of the right hand to a position to change the line thickness of the virtual drawing image 14 while drawing the line of the virtual drawing image 14, and then performs an operation on the slider of the line width operation panel 23 with the left finger, the line thickness of the virtual drawing image 14 is changed. Then, when the user changes the line thickness by using the slider of the line width operation panel 23 and moves the fingertip of the right hand, according to the locus of the fingertip, the virtual drawing image 14 in which the line thickness is continuously changed is created. With this operation, for example, as shown in a lower side of FIG. 4, the virtual drawing image 14 in which the line thickness is continuously changed to increase is created.

Furthermore, similarly, when the user moves the fingertip of the right hand to a position to change the line color of the virtual drawing image 14 while drawing the line of the virtual drawing image 14, and then performs a touch operation on the line color operation panel 24 with the left finger, the line color of the virtual drawing image 14 is changed.

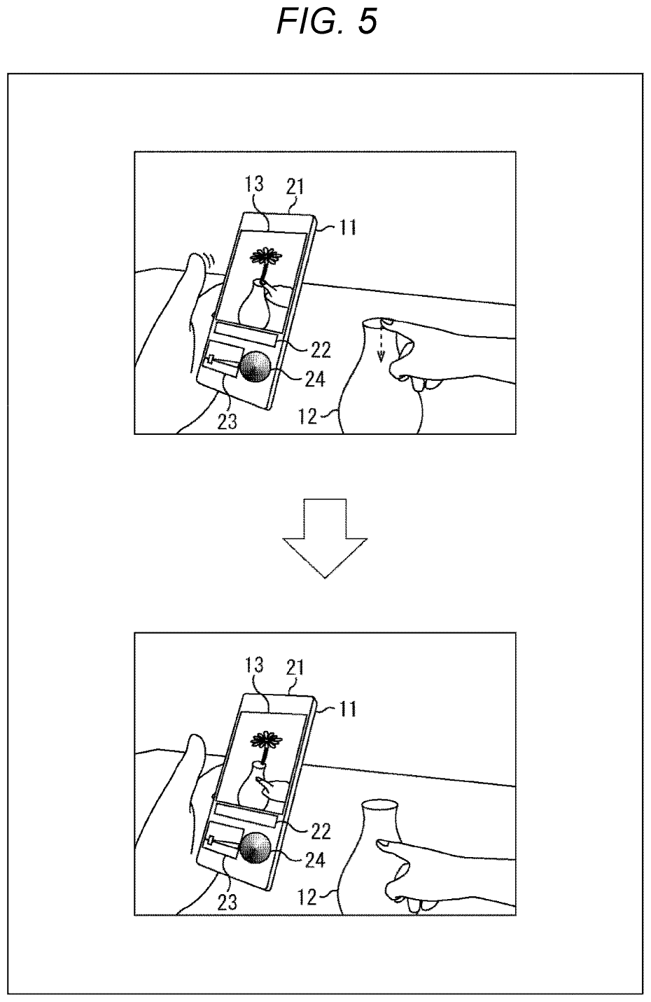

With reference to FIG. 5, a user interface for finishing creation of the virtual drawing image 14 in the AR display application will be described.

For example, as shown in an upper side of FIG. 5, when the user moves the fingertip of the right hand to a position to finish drawing the virtual drawing image 14 and then performs a touch operation to release the touch on the line drawing operation button 22 with the left finger, the creation of the virtual drawing image 14 is finished. Thereafter, even if the user moves the fingertip of the right hand, for example, even if the user moves the fingertip of the right hand by the dashed arrow shown in an upper side of FIG. 5, the line of the virtual drawing image 14 is not drawn on the AR image display screen 13 as shown in a lower side of FIG. 5.

With the above-described user interface, the AR display application can implement the operation to change the line width and line color continuously when creating the virtual drawing image 14. With this configuration, operability with a degree of freedom higher than before can be provided. Furthermore, the user can create the virtual drawing image 14 by moving the fingertip on a real space while checking the virtual drawing image 14 in creation on the AR image display screen 13, and can provide operability that is highly compatible with a real space. Therefore, a better user experience can be implemented by the AR display application.

That is, the AR display application can recognize one hand, finger, or the like captured by the image capturing device of the smartphone 11, follow movement thereof, create the virtual drawing image 14, and continuously reflect the change to the virtual drawing image 14 in creation in response to the operation of the other hand. With this configuration, continuous changes to the virtual drawing image 14 with the degree of freedom higher than before can be implemented.

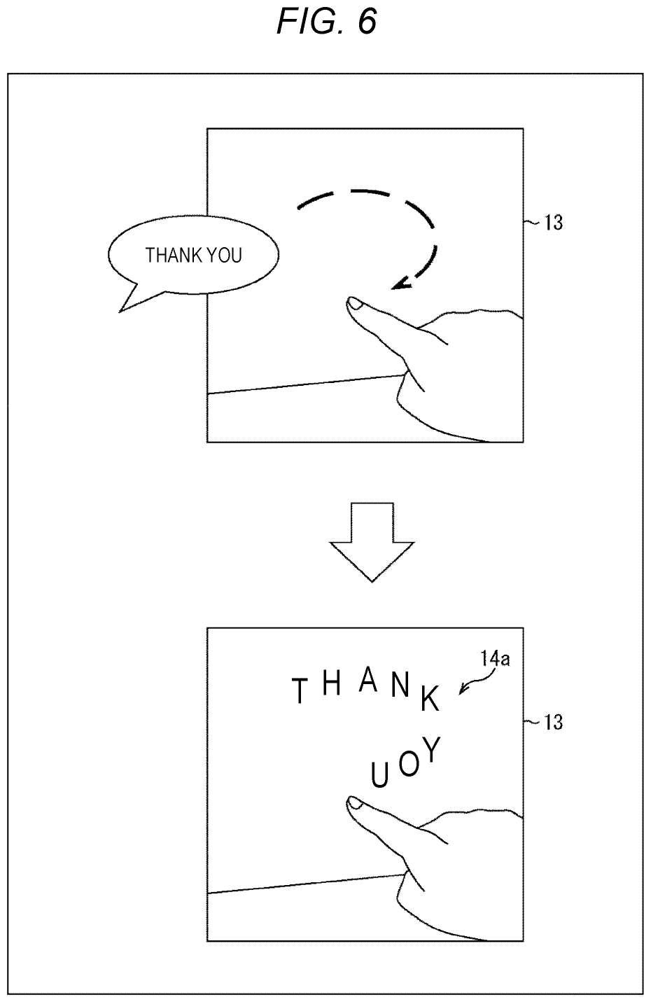

With reference to FIG. 6, a usage example of creating the virtual drawing image 14 on the basis of voice recognition in the AR display application will be described.

For example, when the user gives utterance while moving the fingertip to appear in the image captured by the image capturing device of the smartphone 11, the AR display application can perform voice recognition on the uttered voice and create a virtual drawing image 14a that displays a character string indicating details of the utterance according to the locus of the fingertip. For example, in the example shown in FIG. 6, when the user moves the fingertip while giving utterance “Thank you”, an AR image in which the virtual drawing image 14a that displays a character string “Thank you” according to the locus of the fingertip is placed on a real space is displayed on the AR image display screen 13.

By using such an input by voice recognition, for example, during presentation, a school class, or the like, the AR display application is suitable for use to input a voice with a microphone or the like while pointing with a finger a drawing to explain. That is, it is possible to easily perform use such as virtually placing the character string at the pointed position. Furthermore, the AR display application is also suitably used for, for example, a situation log at a construction site, a precaution for maintenance, or the like.

Configuration Example of Smartphone>

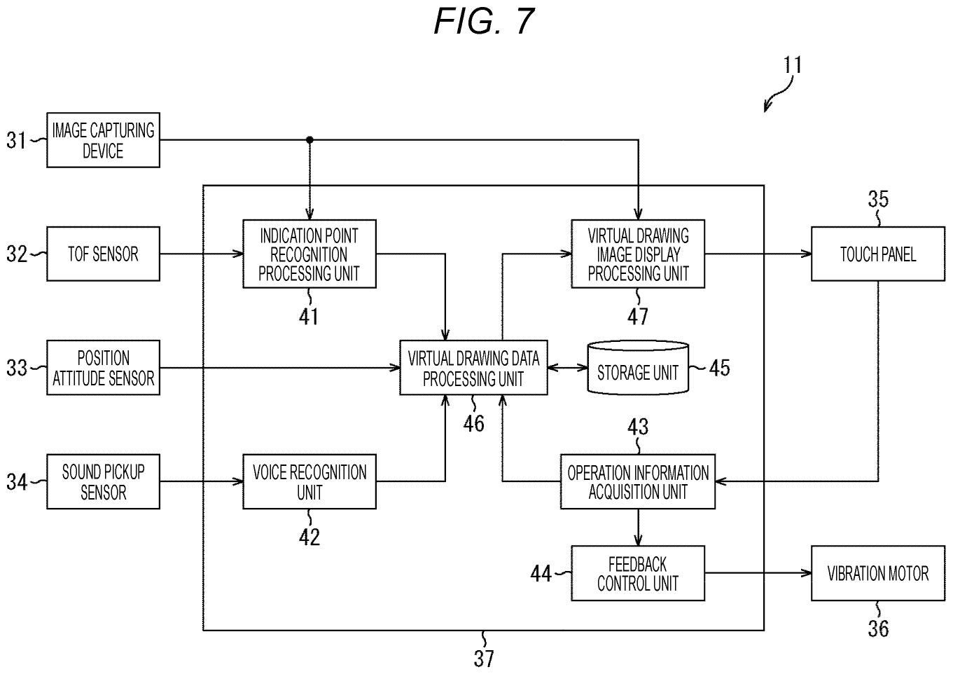

FIG. 7 is a block diagram showing a configuration example of the smartphone 11 that executes the AR display application.

As shown in FIG. 7, the smartphone 11 includes an image capturing device 31, a TOF sensor 32, a position attitude sensor 33, a sound pickup sensor 34, a touch panel 35, a vibration motor 36, and an AR display processing unit 37. Furthermore, the AR display processing unit 37 includes an indication point recognition processing unit 41, a voice recognition unit 42, an operation information acquisition unit 43, a feedback control unit 44, a storage unit 45, a virtual drawing data processing unit 46, and a virtual drawing image display processing unit 47.

The image capturing device 31 includes, for example, a complementary metal oxide semiconductor (CMOS) image sensor or the like, and supplies an image obtained by capturing a real space to the indication point recognition processing unit 41 and the virtual drawing image display processing unit 47 of the AR display processing unit 37.

The TOF sensor 32 includes, for example, a light-emitting unit that emits modulated light toward an image capturing range of the image capturing device 31 and a light-receiving unit that receives reflected light obtained by the modulated light being reflected by an object. With this configuration, the TOF sensor 32 can measure a distance (depth) to the object on the basis of a time difference between timing of emitting the modulated light and timing of receiving the reflected light, and acquire a distance image that is an image based on the distance. The TOF sensor 32 supplies the acquired distance image to the virtual drawing data processing unit 46 of the AR display processing unit 37.

The position attitude sensor 33 includes, for example, a positioning sensor that measures the absolute position of the smartphone 11 by receiving various radio waves, a gyro sensor that measures the attitude on the basis of an angular velocity generated in the smartphone 11, or the like. Then, the position attitude sensor 33 supplies position and attitude information indicating the absolute position and the attitude of the smartphone 11 to the virtual drawing data processing unit 46 of the AR display processing unit 37.

The sound pickup sensor 34 includes, for example, a microphone element, collects a voice uttered by the user, and supplies voice data thereof to the voice recognition unit 42 of the AR display processing unit 37.

The touch panel 35 includes a display unit that displays the application screen 21 described above with reference to FIG. 2, and a touch sensor that detects a touched position on a surface of the display unit. Then, the touch panel 35 supplies touch position information indicating the touched position detected by the touch sensor to the operation information acquisition unit 43 of the AR display processing unit 37.

The vibration motor 36 provides feedback about the user operation by vibrating the smartphone 11 according to the control by the feedback control unit 44 of the AR display processing unit 37.

The AR display processing unit 37 includes respective blocks necessary for executing the AR display application, and implements the user interface as described with reference to FIGS. 1 to 6.

The indication point recognition processing unit 41 recognizes the fingertip captured by the image capturing device 31 as an indication point indicating the locus of the line for drawing the virtual drawing image 14 on the basis of the image supplied from the image capturing device 31 and the distance image supplied from the TOF sensor 32. For example, by performing image recognition processing on the image captured by the image capturing device 31, the indication point recognition processing unit 41 can recognize the fingertip of the user that appears in the image. This allows the indication point recognition processing unit 41 to identify the relative position of the fingertip with respect to the smartphone 11 by obtaining the distance to the fingertip shown in the image according to the distance image, and recognize the indication point. Then, the indication point recognition processing unit 41 supplies relative position information indicating the relative position of the indication point with respect to the smartphone 11 to the virtual drawing data processing unit 46.

The voice recognition unit 42 performs voice recognition processing on the voice data supplied from the sound pickup sensor 34, acquires utterance information obtained by transcribing the voice uttered by the user, and supplies the utterance information to the virtual drawing data processing unit 46.

The operation information acquisition unit 43 acquires operation information indicating details of the operation according to the touch operation by the user on the basis of the application screen 21 displayed on the touch panel 35 and the touch position information supplied from the touch panel 35. For example, as described with reference to FIG. 2, in response to the touch operation on the line drawing operation button 22, the operation information acquisition unit 43 can acquire operation information indicating that creation of the virtual drawing image 14 is started or finished. Furthermore, the operation information acquisition unit. 43 acquires operation information indicating that a change is made to the line width representing the virtual drawing image 14 in response to the touch operation on the line width operation panel 23. Furthermore, the operation information acquisition unit 43 acquires operation information indicating that a change is made to the line color representing the virtual drawing image 14 in response to the touch operation on the line color operation panel 24.

When the operation information indicating that the operation to start the creation of the virtual drawing image 14 has beer, performed is supplied from the operation information acquisition unit 43, the feedback control unit 44 controls the vibration motor 36 to vibrate the vibration motor 36. Then, the feedback control unit 44 continues to vibrate the vibration motor 36 until the generation of the virtual drawing data is finished, and stops the vibration of the vibration motor 36 when the operation information indicating that the operation to finish the generation of the virtual drawing data has been performed is supplied from the operation information acquisition unit 43. This allows the feedback control unit 44 to perform feedback control for causing the user to recognize that the virtual drawing image 14 is being created.

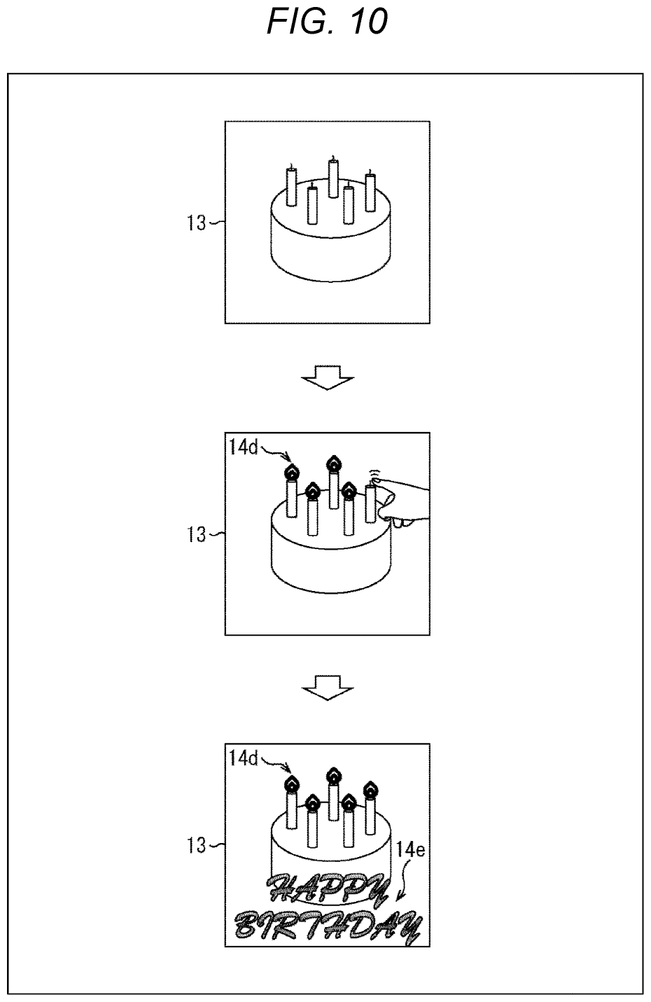

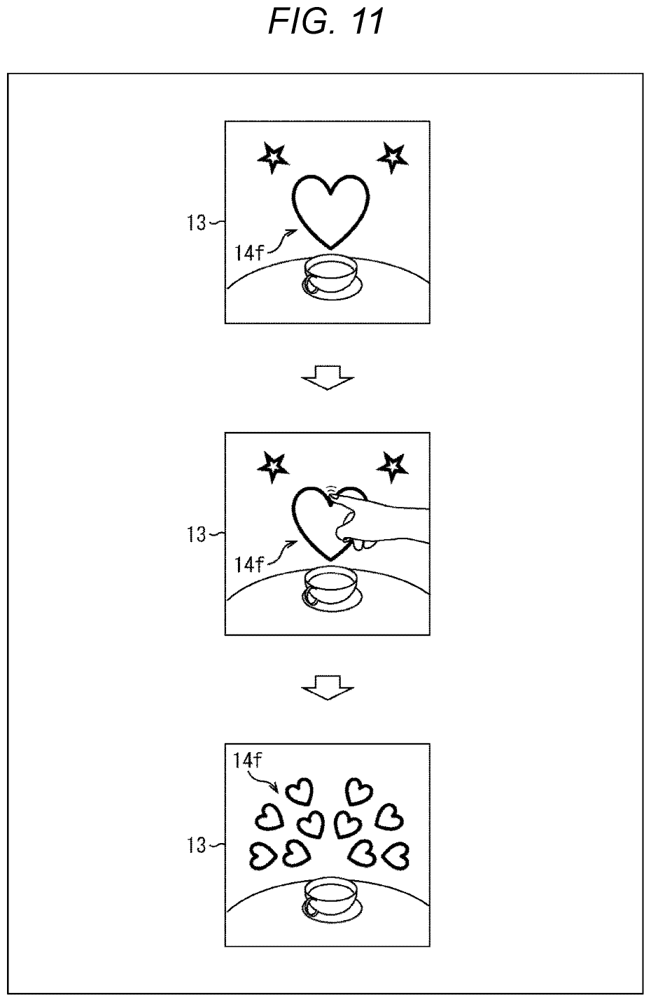

The storage unit 45 stores the virtual drawing data generated by the virtual drawing data processing unit 46. Furthermore, for example, as described later with reference to FIGS. 10 and 11, in association with the predetermined virtual drawing image 14 and specified gesture, the storage unit 45 stores effect data for performing an effect display on the virtual drawing image 14.

The virtual drawing data processing unit 46 performs processing to generate the virtual drawing data for displaying the virtual drawing image 14 on the basis of the position and attitude information supplied from the position attitude sensor 33, the relative position information supplied from the indication point recognition processing unit 41, the utterance information supplied from the voice recognition unit 42, and the operation information supplied from the operation information acquisition unit 43. Then, the virtual drawing data processing unit 46 sequentially supplies the virtual drawing data in generation to the virtual drawing image display processing unit 47, and when the creation of the virtual drawing image 14 is finished, the virtual drawing data processing unit 46 supplies the completed virtual drawing data to the storage unit 45 for storage.

For example, on the basis of the absolute position and attitude of the smartphone 11, the virtual drawing data processing unit 46 can generate the virtual drawing data according to the locus of the indication point by converting the relative position of the indication point with respect to the smartphone 11 into the absolute coordinate system. Then, by associating the timing of the continuous movement of the indication point with the timing of a continuous change operation according to the operation information, the virtual drawing data processing unit 46 can generate the virtual drawing data while reflecting the change in response to the change operation.

Furthermore, as described with reference to FIG. 6, on the basis of the utterance information supplied from the voice recognition unit 42, the virtual drawing data processing unit 46 can generate the virtual drawing data of the virtual drawing image 14a (FIG. 6) in which characters are displayed at every indication point at the timing the user gives utterance.

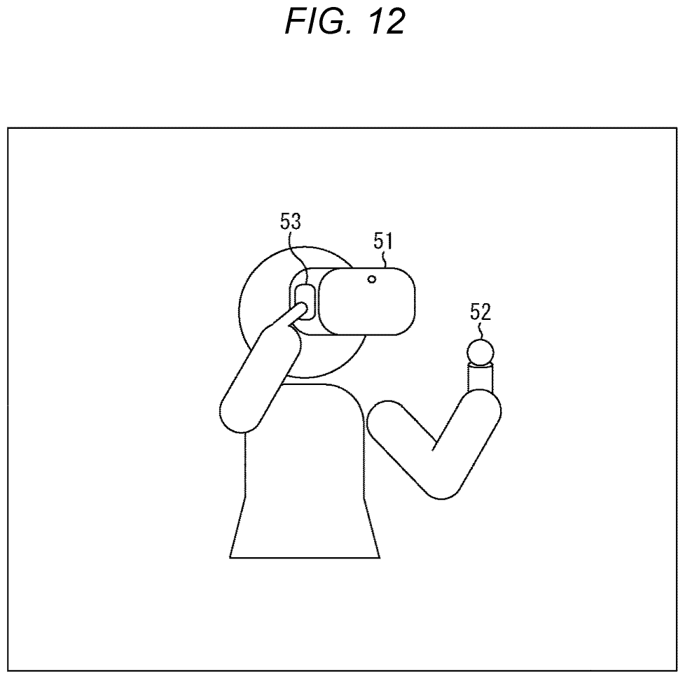

Furthermore, when a reproducing operation for displaying the virtual drawing image 14 is performed according to the virtual drawing data stored in the storage unit 45, the virtual drawing data processing unit 46 reads the virtual drawing data from the storage unit 45 and supplies the read virtual drawing data to the virtual drawing image display processing unit 47 to cause the virtual drawing image display processing unit 47 to perform display processing of the virtual drawing image 14. Moreover, as described later with reference to FIGS. 11 and 12, in a case where the virtual drawing data processing unit 46 recognizes that a specified gesture has been performed on the predetermined virtual drawing image 14, the virtual drawing data processing unit 46 can read the effect data corresponding to the gesture from the storage unit 45 and apply the effect display to the virtual drawing image 14.

The virtual drawing image display processing unit 47 performs display processing to superimpose the virtual drawing image 14 based on the virtual drawing data supplied from the virtual drawing data processing unit 46 on the image in real space supplied from the image capturing device 31 in real time. This allows the virtual drawing image display processing unit 47 to supply the AR image in which the virtual drawing image 14 is virtually placed on a real space to the touch panel 35, and to display the AR image on the AR image display screen 13.

The smartphone 11 is configured as described above. The indication point recognition processing unit 41 can recognize the indication point by following the fingertip moving continuously. The operation information acquisition unit 43 can acquire the operation information indicating details of operation according to the continuous change in the touch operation of the user on the touch panel 35. Then, the virtual drawing data processing unit 46 can generate the virtual drawing data by associating the timing of the continuous change of the fingertip with the timing of continuous change according to the operation information. Therefore, when creating the virtual drawing image 14, it is possible to reflect the change on the virtual drawing image 14 by associating the timing of the operation of the fingertip of one hand that moves continuously with the timing of the operation of the other hand that makes the change continuously. In this way, a good user experience can be provided by the user interface that can implement operability with a higher degree of freedom.

Note that the smartphone 11 can transmit the virtual drawing data stored in the storage unit 45 to another smartphone 11, and the other smartphone 11 can reproduce the virtual drawing image 14 by executing the AR display application. At this time, the virtual drawing data is generated by the absolute coordinate system as described above, and the virtual drawing image 14 can be displayed on the touch panel 35 of the other smartphone 11 at the location where the virtual drawing image 14 is created.

<Display Processing of AR Display Application>

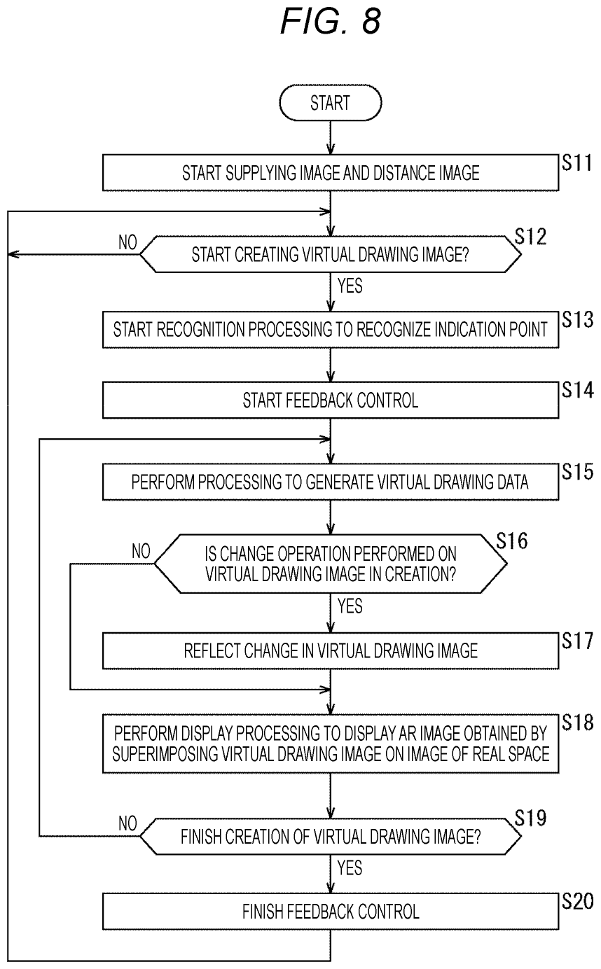

With reference to the flowchart shown in FIG. 8, display processing to be performed in the AR display application will be described.

For example, when the AR display application is executed in the smartphone 11, the display processing is started. In step S11, the image capturing device 31 starts supplying the image to the indication point recognition processing unit 41 and the virtual drawing image display processing unit 47, and the TOF sensor 32 starts supplying the distance image to the indication point recognition processing unit 41.

In step S12, the operation information acquisition unit 43 determines whether or not to start creating the virtual drawing image 14. For example, when the operation information acquisition unit 43 recognizes that the touch operation has been performed on the line drawing operation button 22 in FIG. 2 according to the touch position information supplied from the touch panel 35, the operation information acquisition unit 43 determines to start creating the virtual drawing image 14.

In step S12, until the operation information acquisition unit 43 determines to start creating the virtual drawing image 14, the process is in a standby mode, and in a case where the operation information acquisition unit 43 determines to start creating the virtual drawing image 14, the process proceeds to step S13.

In step S13, the indication point recognition processing unit 41 starts recognition processing to recognize the indication point on the basis of the image supplied from the image capturing device 31 and the distance image supplied from the TOF sensor 32. Then, the indication point recognition processing unit 41 supplies relative position information indicating the relative position of the indication point with respect to the smartphone 11 to the virtual drawing data processing unit 46.

In step S14, the operation information acquisition unit 43 supplies the operation information indicating that the creation of the virtual drawing image 14 is started to the feedback control unit 44, and the feedback control unit 44 starts feedback control by vibrating the vibration motor 36.

In step S15, the virtual drawing data processing unit 46 performs processing to generate the virtual drawing data for displaying the virtual drawing image 14. As described above, the virtual drawing data processing unit 46 changes the relative position information supplied from the indication point recognition processing unit 41 to the absolute coordinate system, and generates the virtual drawing data according to the locus of the indication point.

In step S16, the operation information acquisition unit 43 determines whether or not a change operation has been performed on the virtual drawing image 14 in creation. For example, when the operation information acquisition unit 43 recognizes that the touch operation has been performed on the line width operation panel 23 or the line color operation panel 24 in FIG. 2 according to the touch position information supplied from the touch panel 35, the operation information acquisition unit 43 determines that, a change operation on the virtual drawing image 14 in creation has been performed.

In step S16, in a case where the operation information acquisition unit 43 determines that the change operation has been performed on the virtual drawing image 14 in creation, the process proceeds to step S17. In step S17, the operation information acquisition unit 43 acquires details of the change operation on the virtual drawing image 14 in creation (for example, thickness, color, or the like of the line) and supplies the details to the virtual drawing data processing unit 46. Then, the virtual drawing data processing unit 46 changes the virtual drawing data according to the details of the change operation, thereby reflecting the change in the virtual drawing image 14.

On the other hand, in step S16, in a case where the operation information acquisition unit 43 determines that a change operation has not been performed on the virtual drawing image 14 in creation, or after the processing of step S17, the process proceeds to step S18.

In step S18, the virtual drawing data processing unit 46 supplies the virtual drawing data generated in step S15 or the virtual drawing data reflecting the change in step S17 to the virtual drawing image display processing unit 47. With this operation, the virtual drawing image display processing unit 47 creates the virtual drawing image 14 according to the virtual drawing data supplied from the virtual drawing data processing unit 46. Then, the virtual drawing image display processing unit 47 performs display processing to supply to the touch panel 35 and display the AR image obtained by superimposing the virtual drawing image 14 in creation on the image in a real space captured by the image capturing device 31.

In step S15, the operation information acquisition unit 43 determines whether or not to finish the creation of the virtual drawing image 14. For example, when the operation information acquisition unit 43 recognizes that the touch operation has been finished on the line drawing operation button 22 in FIG. 2 according to the touch position information supplied from the touch panel 35, the operation information acquisition unit 43 determines to finish the creation of the virtual drawing image 14.

In step S15, in a case where the operation information acquisition unit 43 determines not to finish the creation of the virtual drawing image 14, the process returns to step S15. Hereinafter, by repeating similar processing, the creation of the virtual drawing image 14 is continued.

On the other hand, in step S19, in a case where the operation information acquisition unit 43 determines to finish the creation of the virtual drawing image 14, the process proceeds to step S20. In step S20, the operation information acquisition unit 43 supplies the operation information indicating that the creation of the virtual drawing image 14 is finished to the feedback control unit 44, and the feedback control unit 44 finishes feedback control by stopping vibration of the vibration motor 36. Furthermore, at this time, the indication point recognition processing unit 41 finishes the recognition processing to recognize the indication point, and the virtual drawing data processing unit 46 supplies the completed virtual drawing data to the storage unit 45 for storage.

After the processing in step S20, the process returns to step S12, the start of creation of the virtual drawing image 14 is in a standby mode, and hereinafter, similar display processing is repeatedly performed until the AR display application is finished.

<Various Usage Examples of AR Display Application>

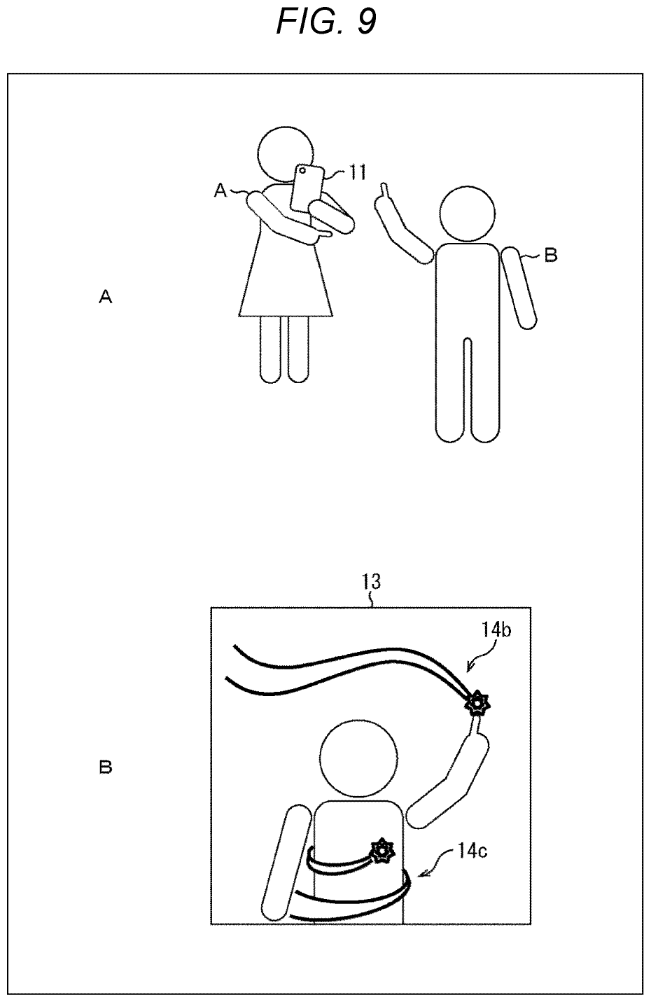

With reference to FIGS. 9 to 12, various usage examples of the AR display application will be described.

A of FIG. 9 shows the user A using the smartphone 11. B of FIG. 9 shows the AR image display screen 13 displayed on the touch panel of the smartphone 11. The AR image display screen 13 shows a first effect display example for a virtual drawing image 14c.

For example, the AR display application can recognize, as the indication point, not only the fingertip of the user A who holds the smartphone 11 but also the fingertip of the user B who does not hold the smartphone 11. Moreover, the AR display application can simultaneously recognize a plurality of indication points, for example, simultaneously recognize the fingertips of the user A and the user B to create two virtual drawing images 14b and 14c, respectively.

Furthermore, as shown in B of FIG. 9, for example, the AR display application can create the virtual drawing image 14b in which the fingertip emits virtual light, and a light trace of the virtual light is displayed continuously for a certain period of time while being diffused.

Moreover, when the AR display application recognizes that a specified gesture has been performed on the predetermined virtual drawing image 14, the AR display application can perform, for example, various effect displays in which the virtual drawing image 14 starts moving. For example, when the AR display application recognizes that a gesture of poking the virtual drawing image 14 has been performed after finishing the creation of the virtual drawing image 14, the AR display application can perform an effect display such as moving along a body surface of the user B as in the virtual drawing image 14c shown in B of FIG. 9.

In addition, the AR display application can perform an effect display in which the virtual drawing image 14 on which characters are drawn stands out, an effect display in which the characters are transformed into the virtual drawing image 14 having a line shape, or the like.

Effect data for performing these effect displays (movement, transformation, or the like of the virtual drawing image 14) is stored in the storage unit 45. For example, when recognizing a specified gesture, the virtual drawing data processing unit 46 reads effect data associated with the gesture from the storage unit 45 and supplies the effect data to the virtual drawing image display processing unit 47. The virtual drawing image display processing unit 47 performs display processing such that the effect display according to the effect data is performed on the virtual drawing image 14 displayed on the AR image display screen 13.

With reference to FIG. 10, a second effect display example for the virtual drawing image 14 will be described.

For example, as shown in an upper part of FIG. 10, the AR display application can recognize by image recognition that a cake with a plurality of candles put thereon is displayed on the AR image display screen 13, and recognizes that the user has performed a gesture of actually touching the tip of one candle. Accordingly, as shown in a middle part of FIG. 10, the AR display application displays, on the AR image display screen 13, a virtual drawing image 14d that seems like a virtual fire is burning at the end of each candle. At this time, the AR display application can perform an effect display in which the fire of the candle flickers. Note that, for example, the virtual drawing image 14 (not shown) of an effect display in which virtual fireworks are set off in superimposition on the cake may be displayed on the AR image display screen 13.

Then, when the virtual fire of the virtual drawing image 14d is displayed for all the candles, as shown in a lower part of FIG. 10, the AR display application displays characters “HAPPY BIRTHDAY” of a virtual drawing image 14e that appears to float three-dimensionally in space. Furthermore, as the user performs an operation on the line color operation panel 24 of FIG. 2, the AR display application can change the color of the characters of the virtual drawing image 14e to an arbitrary color or to gradation drawn with a multicolored brush. In addition, as an operation to select various decorations for characters set in advance is performed, the AR display application can continuously change the decoration of the characters of the virtual drawing image 14e.

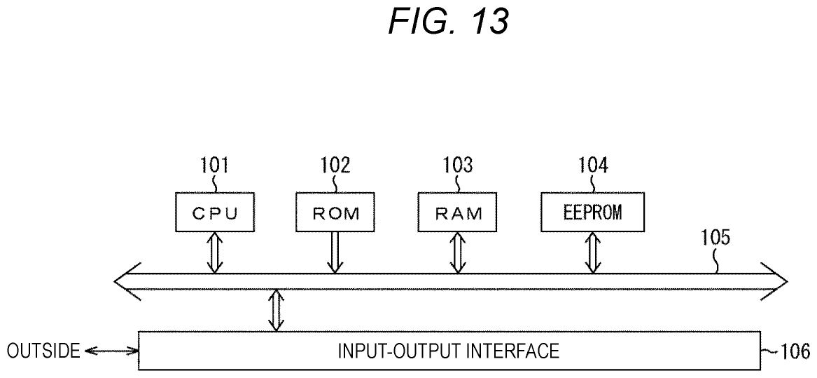

With reference to FIG. 13, a third effect display example for the virtual drawing image 14 will be described.

For example, as shown in an upper pare of FIG. 11, the AR display application displays a virtual drawing image 14f drawn by a line in a heart shape above a coffee cup on the AR image display screen 13. Furthermore, the AR display application can perform an effect display in which a heart shape appears to be shining around an AR image display screen 13f. Furthermore, in addition, the AR display application may perform an effect display in which the heart shape itself is shining or burning.

Then, the AR display application recognizes that the user has performed a gesture of dividing the heart shape of the virtual drawing image 14f with the fingertip as shown in a middle part of FIG. 11. In response to this recognition, as shown in a lower part of FIG. 11, the AR display application can perform, on the virtual drawing image 14f, an effect display in which a plurality of small heart shapes springs out of the broken heart shape and jumps out.

With reference to FIG. 12, an example of applying the AR display application to virtual reality will be described.

For example, in addition to displaying the virtual drawing image 14 in superimposition on a real space, the virtual drawing image 14 may be displayed in superimposition on a virtual space created by computer graphics.

For example, as shown in FIG. 12, the user can create the virtual drawing image 14 by wearing a head mount display 51 and holding a controller 52 used as an indication point. At this time, an operation of indicating start or finish of the creation of the virtual drawing image 14, an operation of indicating a change to the virtual drawing image 14, or the like can be performed by using a touch panel 53 provided on a side surface of the head mount display 51.

Moreover, the AR display application may be applied to mixed reality, and the virtual drawing image 14 may be superimposed and displayed on a real space actually viewed by the user by using a transmission type head mount display.

Furthermore, the AR display application is assumed to have various use cases as described below.

For example, while watching the touch panel 35 of one smartphone 11 together, two users sitting side by side in a cafe or the like can create the virtual drawing image 14 representing a picture, a message, or the like for a desk surface, coffee cups, cakes, or the like. Then, the AR image display screen 13 in which the completed virtual drawing image 14 is displayed can be recorded as a moving image and open to a social network. Alternatively, the AR image display screen 13 in a progress state of creating the virtual drawing image 14 may be recorded as a moving image in a time-lapse manner.

For example, when a celebrity goes to a restaurant, by using the celebrity's smartphone 11, the celebrity can create the virtual drawing image 14 representing a three-dimensional message, signature, or the like on a real space from a place where the celebrity himself or herself is seated for a meal. Then, the virtual drawing image 14, spatial information, global positioning system (GPS) location information, or other data can be open to a social network. With this configuration, those who have viewed the social network can go to the restaurant where the celebrity has had a meal on the basis of the open data, and display and view the three-dimensional message or signature on the AR image display screen 13 by using the smartphone 11 of each person. At this time, it is possible to capture a still image such that the person himself or herself is captured together with the AR image display screen 13.

For example, when a father comes home at midnight while children are sleeping at home and points the camera of the smartphone 11 at a meal, the virtual drawing image 14 representing a message left by the children is displayed on the AR image display screen 13 in superimposition on the meal. This virtual drawing image 14 is created using the mother's smartphone 11 before the children go to bed.

For example, when making a group tour to Kyoto for a graduation trip, the virtual drawing image 14 in which everyone of the group writes a few words can be created at a certain tourist spot by using the smartphone 11. Then, when going to the tourist spot several years after the graduation, it is possible to display the virtual drawing image 14 on the AR image display screen 13 for viewing, to add a new virtual drawing image 14 by using the smartphone 11, or the like.

For example, at a desk of a child having a birthday at school, on the day before the child's birthday, friends of the child can use their smartphones 11 to create the virtual drawing image 14 in which the friends write congratulatory words such as Happy Birthday, illustrations, and the like. Then, on the day of the birthday, when the child captures his or her desk with his or her smartphone 11 camera, the virtual drawing image 14 showing the congratulatory message of the friends is displayed on the AR image display screen 13 like the virtual drawing image 14 is superimposed on the desk in real space.

For example, at a place where there are many graffiti, instead of real graffiti, a creator or general person can use his or her smartphone 11 to create the virtual drawing image 14 representing artistic graffiti. Then, when a passer-by captures the place with the camera of his or her smartphone 11, the virtual drawing image 14 representing the artistic graffiti can be displayed and viewed on the AR image display screen 13.

For example, a visitor to an art museum, a museum, or the like can use his or her smartphone 11 to create the virtual drawing image 14 showing his or her impressions, comments, or the like, and virtually leave the virtual drawing image 14 in the space where a work is displayed. Then, another customer who similarly visits the museum, using his or her own smartphone 11, displays and views the virtual drawing image 14 representing the virtual drawing image 14 representing impressions, comments, or the like on the AR image display screen 13, thereby feeling and enjoying a difference in sensibility, interpretation, or the like between this customer and the customer who has left the impression, comments, or the like.

For example, when giving a school backpack as a present for a grandchild's entrance ceremony, the grandparents can use the smartphone 11 to create in advance the virtual drawing image 14 representing a message, an illustration, or the like in superimposition on the school backpack. Thereafter, the grandparents give as a present virtual drawing data for displaying the virtual drawing image 14 together with the school backpack. With this configuration, when the grandchild captures the school backpack with the camera of the smartphone 11, the smartphone 11 recognizes the school backpack (object recognition), whereby the grandchild can display and view the virtual drawing image 14 representing the message, the illustration, or the like displayed in superimposition on the school backpack on the AR image display screen 13. Moreover, a still image of the AR image display screen 13 in which the grandchild carrying the school backpack appears together with the virtual drawing image 14 representing the message, the illustration, or the like can be recorded as a commemorative photo and transmitted to the grandparents.

In this way, the AR display application can create a handwritten message, picture, or the like at a certain place as the virtual drawing image 14 by measuring the distance to the fingertip, and virtually leave the virtual drawing data for displaying the virtual drawing image 14 in a real space. At this time, GPS data and spatial data can be recorded within the AR display application together with the virtual drawing data of the virtual drawing image 14. This makes it possible to reproduce the virtual drawing image 14 by executing the AR display application and reading the record when going to the place next time. That is, the AR display application records simultaneous localization and mapping (SLAM) information, spatial information, and GPS information together with the virtual drawing data for displaying the virtual drawing image 14, thereby enabling re-localization.

Furthermore, the smartphone 11 can use various methods such as using a stereo camera to recognize the three-dimensional position of the fingertip, in addition to using the TOF sensor 32. Moreover, in addition to changing the line thickness of the virtual drawing image 14 by using the line width operation panel 23 of FIG. 2, the smartphone 11 may, for example, detect touch pressure on the touch panel 35 and change the line thickness of the virtual drawing image 14 according to the touch pressure.

<Configuration Example of Computer>

Note that respective processes described with reference to the above-described flowcharts do not necessarily need to be processed on a time-series basis in the order described as the flowcharts, and processes to be performed in parallel or individually (for example, parallel processing or processing by objects) are also included. Furthermore, the program may be processed by one CPU or may be processed in a distributed manner by a plurality of CPUs.

Furthermore, a series of processes described above (display processing method) can be performed by hardware, or can be performed by software. In a case where the series of processes is performed by software, the program that constitutes the software is installed from a program recording medium in which the program is recorded to a computer built in dedicated hardware or, for example, a general-purpose personal computer or the like that can execute various functions by installing various programs.

FIG. 13 is a block diagram showing a configuration example of hardware of a computer that performs the series of processes described above by the program.

In the computer, a central processing unit (CPU) 101, a read only memory (RCM) 102, a random access memory (RAM) 103, and an electronically erasable and programmable read only memory (EEPROM) 104 are interconnected by a bus 105. An input-output interface 106 is further connected to the bus 105, and the input-output interface 106 is connected to the outside.

In the computer configured as described above, the CPU 101 loads, for example, a program stored in the ROM 102 and the EEPROM 104 into the RAM 103 via the bus 105 and executes the program, whereby the above-described series of processes is performed. Furthermore, the program to be executed by the computer (CPU 101) can be installed or updated in the EEPROM 104 from the outside via the input-output interface 106 in addition to being written in the ROM 102 in advance.

<Combination Example of Configuration>

Note that the present technology can also have the following configurations.

(1)

A display processing device including:

a recognition processing unit configured to perform recognition processing to recognize an indication point that indicates a point on a real space for creating a virtual drawing image that is an image virtually drawn;

an operation information acquisition unit configured to acquire operation information according to a user operation that makes a change to the virtual drawing image in creation;

a data processing unit configured to generate virtual drawing data for drawing the virtual drawing image created according to the indication point, while reflecting the change according to the operation information; and

a display processing unit configured to perform display processing to display the virtual drawing image in creation on a display screen in real time on the basis of the virtual drawing data.

(2)

The display processing device according to (1) described above, in which

the operation information acquisition unit acquires the operation information in response to a touch operation of a user on a touch panel including a display unit that displays the display screen.

(3)

The display processing device according to (2) described above, in which

the recognition processing unit recognizes the indication point by following the point moving continuously,

the operation information acquisition unit acquires the operation information according to a continuous change in the touch operation of the user on the touch panel, and

the data processing unit associates timing of continuous movement of the point indicated by the indication point with timing of the continuous change according to the operation information to generate the virtual drawing data.

(4)

The display processing device according to any one of (1) to (3) described above, in which

on the basis of a time difference between timing of emitting light and timing of receiving reflected light obtained by the light being reflected by an object, the recognition processing unit recognizes the indication point by using a distance image acquired by a time of flight (TOF) sensor that obtains a distance to the object.

(5)

The display processing device according to any one of (1) to (4) described above, further including

a feedback control unit configured to feed back to a user that the virtual drawing image is being created.

(6)

The display processing device according to any one of (1) to (5) described above, further including

a voice recognition unit configured to recognize a voice uttered by a user to acquire utterance information obtained by transcribing the voice, in which

the data processing unit generates the virtual drawing data for drawing the virtual drawing image in which a character based on the utterance information is virtually placed at a position indicated by the indication point at timing when the character is uttered.

(7)

The display processing device according to any one of (1) to (6) described above, further including

a storage unit configured to store the virtual drawing data generated by the data processing unit, in which

the data processing unit supplies the virtual drawing data read from the storage unit to the display processing unit to perform the display processing of the virtual drawing image.

(6)

A display processing method to be executed by a display processing device that displays a virtual drawing image that is an image virtually drawn, the method including:

performing recognition processing to recognise an indication point indicating a point on a real space for creating the virtual drawing image;

acquiring operation information according to a user operation that makes a change to the virtual drawing image in creation;

generating virtual drawing data for drawing the virtual drawing image created according to the indication point, while reflecting the change according to the operation information; and

performing display processing to display the virtual drawing image in creation on a display screen in real time on the basis of the virtual drawing data.

(9)

A program for causing a computer of a display processing device that displays a virtual drawing image that is an image virtually drawn to perform display processing including:

performing recognition processing to recognize an indication point indicating a point on a real space for creating the virtual drawing image;

acquiring operation information according to a user operation that makes a change to the virtual drawing image in creation;

generating virtual drawing data for drawing the virtual drawing image created according to the indication point, while reflecting the change according to the operation information; and

performing display processing to display the virtual drawing image in creation on a display screen in real time on the basis of the virtual drawing data.

Note that the present embodiment is not limited to the embodiment described above, and various modifications may be made without departing from the spirit of the present disclosure. Furthermore, effects described in the present specification are merely illustrative and not restrictive, and other effects may be produced.

### REFERENCE SIGNS LIST

11 Smartphone
12 Vase
13 AR image display screen
14 Virtual drawing image
21 Application screen
22 Line drawing operation button
23 Line width operation panel
24 Line color operation panel
31 Image capturing device
32 TOF sensor
33 Position attitude sensor
34 Sound pickup sensor
35 Touch panel
36 Vibration motor
37 AR display processing unit
41 Indication point recognition processing unit
42 Voice recognition unit
43 Operation information acquisition unit
44 Feedback control unit
45 Storage unit
46 Virtual drawing data processing unit
47 Virtual drawing image display processing unit
51 Head mount display
52 Controller
53 Touch panel

1. A display processing device comprising:
a recognition processing unit configured to perform recognition processing to recognize an indication point that indicates a point on a real space for creating a virtual drawing image that is an image virtually drawn;
an operation information acquisition unit configured to acquire operation information according to a user operation that makes a change to the virtual drawing image in creation;
a data processing unit configured to generate virtual drawing data for drawing the virtual drawing image created according to the indication point, while reflecting the change according to the operation information; and
a display processing unit configured to perform display processing to display the virtual drawing image in creation on a display screen in real time on a basis of the virtual drawing data.

2. The display processing device according to claim 1, wherein
the operation information acquisition unit acquires the operation information in response to a touch operation of a user on a touch panel including a display unit that displays the display screen.

3. The display processing device according to claim 2, wherein
the recognition processing unit recognizes the indication point by following the point moving continuously,
the operation information acquisition unit acquires the operation information according to a continuous change in the touch operation of the user on the touch panel, and
the data processing unit associates timing of continuous movement of the point indicated by the indication point with timing of the continuous change according to the operation information to generate the virtual drawing data.

4. The display processing device according to claim 1, wherein
on a basis of a time difference between timing of emitting light and timing of receiving reflected light obtained by the light being reflected by an object, the recognition processing unit recognizes the indication point by using a distance image acquired by a time of flight (TOF) sensor that obtains a distance to the object.

5. The display processing device according to claim 1, further comprising
a feedback control unit configured to feed back to a user that the virtual drawing image is being created.

6. The display processing device according to claim 1, further comprising
a voice recognition unit configured to recognize a voice uttered by a user to acquire utterance information obtained by transcribing the voice, wherein
the data processing unit generates the virtual drawing data for drawing the virtual drawing image in which a character based on the utterance information is virtually placed at a position indicated by the indication point at timing when the character is uttered.

7. The display processing device according to claim 1, further comprising
a storage unit configured to store the virtual drawing data generated by the data processing unit, wherein
the data processing unit supplies the virtual drawing data read from the storage unit to the display processing unit to perform the display processing of the virtual drawing image.

8. A display processing method to be executed by a display processing device that displays a virtual drawing image that is an image virtually drawn, the method comprising:
performing recognition processing to recognize an indication point indicating a point on a real, space for creating the virtual drawing image;
acquiring operation information according to a user operation that makes a change to the virtual drawing image in creation;
generating virtual drawing data for drawing the virtual drawing image created according to the indication point, while reflecting the change according to the operation information; and
performing display processing to display the virtual drawing image in creation on a display screen in real time on a basis of the virtual drawing data.

9. A program for causing a computer of a display processing device that displays a virtual drawing image that is an image virtually drawn to perform display processing comprising:
performing recognition processing to recognize an indication point indicating a point on a real space for creating the virtual drawing image;
acquiring operation information according to a user operation that makes a change to the virtual drawing image in creation;
generating virtual drawing data for drawing the virtual drawing image created according to the indication point, while reflecting the change according to the operation information; and
performing display processing to display the virtual drawing image in creation on a display screen in real time on a basis of the virtual drawing data.
